(19) United States
(12) Patent Application Publication
(10) Pub. No.: US 2025/0306893 A1
(43) Pub. Date: Oct. 2, 2025

(54) MOBILE BODY CONTROL DEVICE, MOBILE BODY CONTROL METHOD, AND STORAGE MEDIUM

(71) Applicant: HONDA MOTOR CO., LTD., Tokyo (JP)

(72) Inventor: Hisahiro Kato, Tokyo (JP)

(21) Appl. No.: 19/008,772

(22) Filed: Jan. 3, 2025

(30) Foreign Application Priority Data
Mar. 27, 2024 (JP) 2024-051652

(51) Int. Cl. G06F 8/65

(52) U.S. Cl. CPC G06F 8/65

(57) ABSTRACT

A mobile body control device includes memories which are formed of a rewritable dual bank ROM, software is written in one of two banks of each of the memories, and the software of a new version is written in an unoccupied bank to execute the update process of the software. When the software is not written in the other bank of the memory, the mobile body control device performs the process of writing unique information of a mobile body written in a further memory into the other bank of the memory.

### INCORPORATION BY REFERENCE

The present application claims priority under 35 U.S.C. § 119 to Japanese Patent Application No. 2024-051652 filed on Mar. 27, 2024. The content of the application is incorporated herein by reference in its entirety.

### BACKGROUND OF THE INVENTION

### Field of the Invention

The present invention relates to a mobile body control device, a mobile body control method, and a storage medium.

### Description of the Related Art

A technology to support software update has conventionally been proposed for control devices mounted on mobile bodies such as vehicles. For example, Japanese Patent Laid-Open No. 2022-049975 discloses the configuration in which setting values and learning values used for software are stored in one of two different banks in the same memory component or one of two areas corresponding to different memory components, and after update software is written in the other of the banks or areas, the setting values and learning values stored in the one bank or area are copied to the other bank or area to allow the setting values and learning values to be used for control continuously even after the software update.

When setting value information is lost due to some reason, operation based on original settings is not possible. For example, in the case of vehicles, a situation where equipment cannot be used properly and a situation where proper detection using sensors cannot be performed may occur. When such situations occur, the vehicles need to be taken to dealers.

To solve the above problem, an object of this application is to improve the reliability of a unique information of a mobile body and to enable the mobile body to continue normal operation. Accordingly, this application contributes to the development of sustainable transportation systems by further enhancing the safety of the traffic.

### SUMMARY OF THE INVENTION

One aspect of the present disclosure is a mobile body control device, including: a processor; a memory that stores software used by the processor, the memory being a rewritable dual bank ROM with the software being written in one of two banks; a software update unit that writes the software of a new version into an unoccupied bank and executes a software update process; a further memory in which a unique information of the mobile body is written; and a backup control unit that writes the unique information into another bank of the memory when the software is not written in the other bank.

Another aspect of the present disclosure is a mobile body control method executed by a mobile body control device including a processor, a first memory that stores software used by the processor, and a second memory in which a unique information of a mobile body is written, the memory being a rewritable dual bank ROM with the software being written in one of two banks, the method including: a software update step of writing the software of a new version in an unoccupied bank and executing a software update process; and a backup step of writing the unique information in another bank of the memory when the software is not written in the other bank.

Another aspect of the present disclosure is a program for causing at least some part of a mobile body control device, including a processor, a memory that is a rewritable dual bank ROM that stores software used by the processor, the software being written in one of two banks, and a further memory in which a unique information of the mobile body is written, to function as: a software update unit that writes the software of a new version into an unoccupied bank and executes a software update process; and a backup control unit that writes the unique information into another bank of the memory when the software is not written in the other bank.

According to one aspect of the present invention, it is possible to improve the reliability of the unique information of a mobile body and to enable the mobile body to continue normal operation.

### BRIEF DESCRIPTION OF THE DRAWINGS

FIG. 1 is a configuration diagram of a mobile body control device;

FIG. 2 is a diagram used to explain how a supplier writes software and writes a unique information;

FIG. 3 is a diagram used to explain backup of the unique information in a manufacturing process;

FIG. 4 is a diagram used to explain a software update process and a backup process of the unique information; and

FIG. 5 is a diagram used to explain the software update process and the backup process of the unique information.

### DETAILED DESCRIPTION OF THE INVENTION

### [1. Configuration of Mobile Body Control Device]

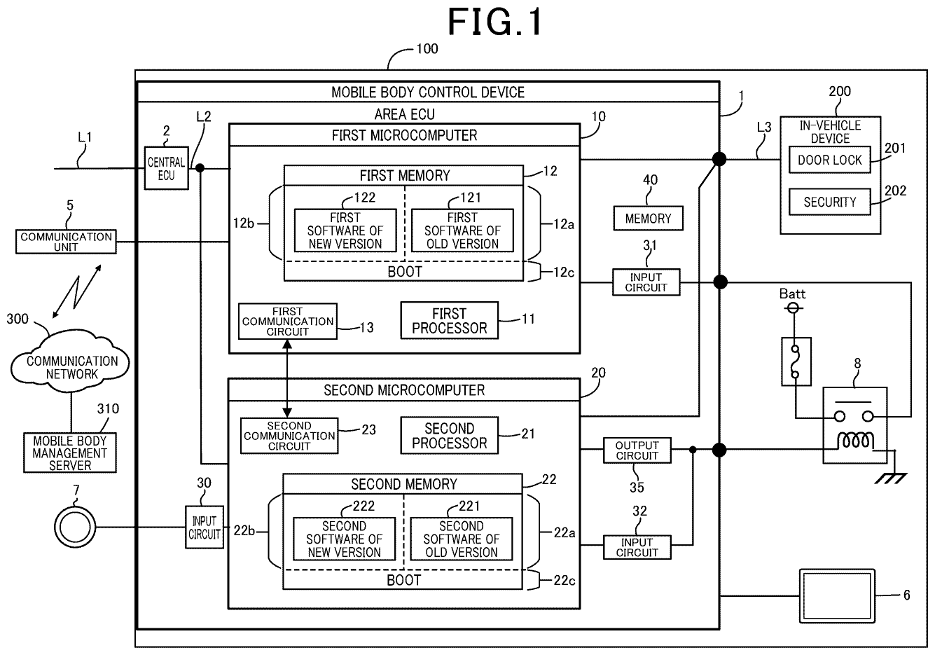

The configuration of a mobile body control device 1 of an embodiment is described with reference to FIG. 1. The mobile body control device 1 includes a central ECU 2 having a processor that performs overall control and information processing of a mobile body 100. In the present embodiment, the case where the mobile body 100 is a vehicle is illustrated, though the mobile body 100 is not limited to a vehicle and may be an aircraft, a ship, or the like.

The central ECU 2 is connected to a communication line including communication lines L1 to L3. The central ECU 2 is connected to a plurality of ECUs for controlling the operation of the mobile body 100 via the communication line to implement the function of a gateway that manages transfer of communication data. FIG. 1 shows, out of the plurality of ECUs, an area ECU that controls the operation of the functions (door lock and security) that are operable while the mobile body 100 is stopped, together with its peripheral configuration.

The area ECU includes a first microcomputer 10 and a second microcomputer 20.

The communication line is a bus that performs communication in conformity with the standards of a controller area network ((CAN), registered trademark), a CAN with flexible data rate (CAN FD), a local interconnect network (LIN), an Ethernet (registered trademark), a FlexRay (registered trademark), or the like. Note that one of the communication lines L1 to L3 or the like may be used for communication that conforms to different standards.

The central ECU 2 writes software (programs), which are executed by the plurality of ECUs connected via the communication line and other ECUs connected via the ECUs, into the respective ECUs. The writing of software includes updating the software already written in the ECUs and writing new software into the ECUs.

This means that the central ECU 2 also functions as an over the air (OTA) manager that performs OTA management. The OTA management includes, for example, the process of downloading the software of an updated version of each ECU included in the mobile body 100 from an external server and the control related to the software update process.

The mobile body 100 includes a communication unit 5 that includes a transmitter and a receiver and that performs wireless communication with a mobile body management server 310 or the like via a communication network 300, and a display 6 that functions as a notification unit that notifies various information to a user of the mobile body 100. Although the communication unit 5 and the display 6 are connected to the mobile body control device 1, they may be included in the mobile body control device 1.

The mobile body control device 1 is also connected to an in-vehicle device 200 mounted on the mobile body 100 via the communication line L3. The in-vehicle device 200 includes a configuration related to the functions that operate while the mobile body 100 is stopped. In the present embodiment, the in-vehicle device 200 includes a door lock module 201 and a security module 202. The door lock module 201 and the security module 202 are connected to at least one of the first microcomputer 10 and the second microcomputer 20 via the communication line L3.

The first microcomputer 10 and the second microcomputer 20 execute controls and processes assigned to the area ECU. The first microcomputer 10 includes a first processor 11, a first memory 12, a first communication circuit 13, and the like. When the first processor 11 executes the first software stored in the first memory 12, operations such as locking or unlocking of the door lock module 201, and activating or deactivating headlights and wipers of the mobile body 100 are performed.

The second microcomputer 20 includes a second processor 21, a second memory 22, a second communication circuit 23, and the like. When the second processor 21 executes the second software stored in the second memory 22, operations such as controlling an electric power supply of the in-vehicle device 200, and setting the security module 202 are performed.

The controls and processes assigned to the respective microcomputers 10 and 20 may be changed as appropriate. In addition, the area ECU is not limited to the configuration including the two microcomputers 10 and 20, and may have a configuration including one microcomputer or three or more microcomputers.

The mobile body 100 includes a start/stop (SS) switch 7 that can instruct switching between an ignition (IG) on (power on state) and IG off (power off state) of the mobile body 100.

As shown in FIG. 1, an operation signal of the SS switch 7 (on/off state of the SS switch 7) is input into the second microcomputer 20 via an input circuit 30. The first microcomputer 10 is connected to an IG relay 8 via an input circuit 31. In response to a control signal output from the second microcomputer 20 via the output circuit 35, on/off control of the IG relay 8 is performed, and the IG on and IG off of the mobile body 100 are switched.

An on/off detection signal of the IG relay 8 (on/off state of the IG relay 8) is input into the first microcomputer 10 via the input circuit 31 and is also input into the second microcomputer 20 via an input circuit 32.

The first memory 12 and the second memory 22 are code flash memories of the area ECU, which are formed of a rewritable non-volatile memory.

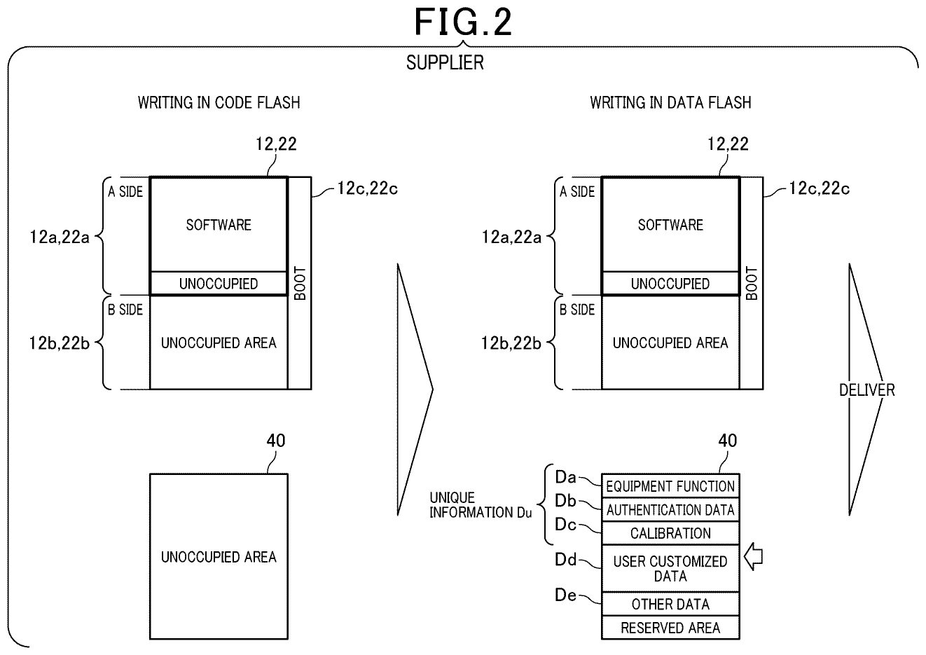

As shown in FIG. 2, a supplier manufacturing the area ECU and the like writes the first software and the second software into the memories 12 and 22, respectively. In this description, the first software and the second software are stated as “software” unless they need to be distinguished from each other.

In the present embodiment, a rewritable dual bank ROM (two-sided ROM) is applied to the first memory 12 and the second memory 22. As shown in FIG. 2, the software is written into one bank of each of the memories 12 and 22 (A-side banks 12a and 22a in the present example). Therefore, each of the other banks (B-side banks 12b and 22b in the present example) becomes an unoccupied area (unoccupied bank).

The respective memories 12 and 22 include areas 12c and 22c, where boot (bootstrap) process programs for the respective microcomputers 10 and 20 are stored. Each of the microcomputers 10 and 20 functions as a software update unit, a backup control unit and the like, when the first processor 11 and the second processor 21 execute the respective boot process programs.

As shown in FIG. 1, the area ECU includes a rewritable non-volatile memory 40 that forms a data flash memory of the area ECU. The supplier manufacturing the area ECU and the like writes data of the mobile body 100, such as equipment function data Da, authentication data Db, calibration data Dc, user customized data Dd, and other data De into the non-volatile memory 40 as shown in FIG. 2.

The equipment function data Da indicates the equipment (including specifications) of the mobile body 100. The equipment function data Da makes it possible to specify equipment and specifications of the mobile body 100, which are different from destination to destination, and equipment and specifications set independently for the mobile body 100. The authentication data Db is used for prescribed authentication. The calibration data Dc is used for assembling specified parts into the mobile body 100 and used for setting an external sensor or the like included in the mobile body 100.

The user customized data Dd indicates the contents customized by the user (occupant) of the mobile body 100. The user customized data Dd is rewritten as needed each time the user customizes the data. The other data De has the contents not particularly limited.

Of the data Da to De written into the non-volatile memory 40, the equipment function data Da, the authentication data Db, and the calibration data Dc are unique to the mobile body 100 and are basically unchanged.

The equipment function data Da, the authentication data Db, and the calibration data Dc are examples of “unique information of the mobile body” in the present disclosure. Hereinafter, for the convenience of explanation, the equipment function data Da, the authentication data Db, and the calibration data Dc are stated as “unique information Du” unless they need to be distinguished from each other.

Incidentally, when the unique information Du written in the non-volatile memory 40 is lost for some reason, the mobile body control device 1 or the like cannot perform controls such as the control based on the unique information Du.

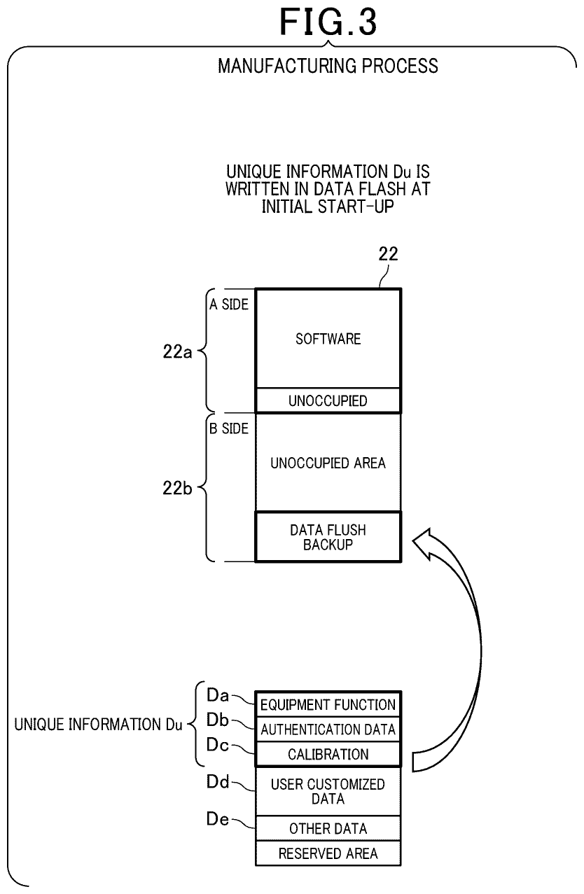

Accordingly, in the present embodiment, at an initial start-up (at an initial power on, e.g., at the IG on by the SS switch 7) in the manufacturing process of the mobile body 100, the second microcomputer 20 of the area ECU performs the process of reading the unique information Du and writing the read unique information Du into the B-side bank 22b that is an unoccupied bank of the second memory 22, as shown in FIG. 3.

In the present embodiment, description is given of the case where the second microcomputer 20 writes the unique information Du into the unoccupied bank of the second memory 22 for backing up the unique information Du, though the first microcomputer 10 may write the unique information Du into the first memory 12 for backing up the unique information Du. Moreover, the second microcomputer 20 and the first microcomputer 10 may write the unique information Du into the second memory 22 and the first memory 12 for backing up the unique information Du, respectively.

Thus, automatically backing up the unique information Du at the start-up of the mobile body 100 can restrain the situation where the unique information Du is lost.

Incidentally, the unoccupied bank of the second memory 22 is the area to be used during update of the second software. Therefore, in the case of performing the update process of the software, the software is updated and also the backup process is performed for backing up the unique information Du in the unoccupied bank that becomes unoccupied after the update. Hereinafter, the software update process and the backup process are described.

Note that the software update process is an example of the software update step in the present disclosure, and the backup process corresponds to an example of the backup control step in the present disclosure.

### [2. Software Update Timing]

The mobile body control device 1 updates the first software and the second software through the OTA management by performing wireless communication with the mobile body management server 310 via the communication network 300 using the communication unit 5.

The first software is updated by the first processor 11 executing a boot process program stored in the area 12c of the first memory 1. The second software is updated by the second processor 21 executing a boot process program stored in the area 22c of the second memory 22.

### [3. Operation of Mobile Body Control Device During Software Update]

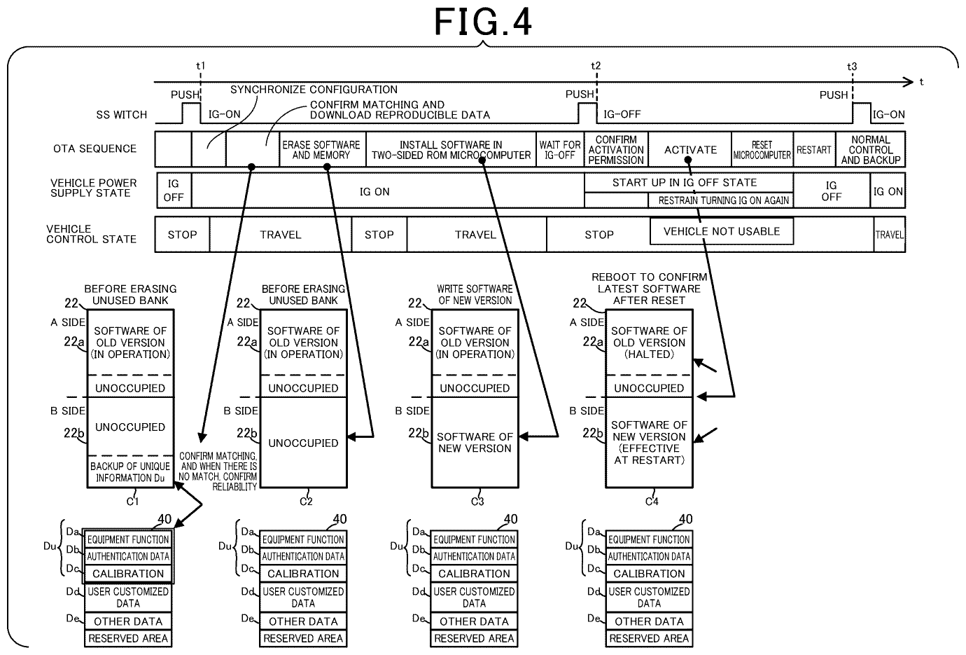

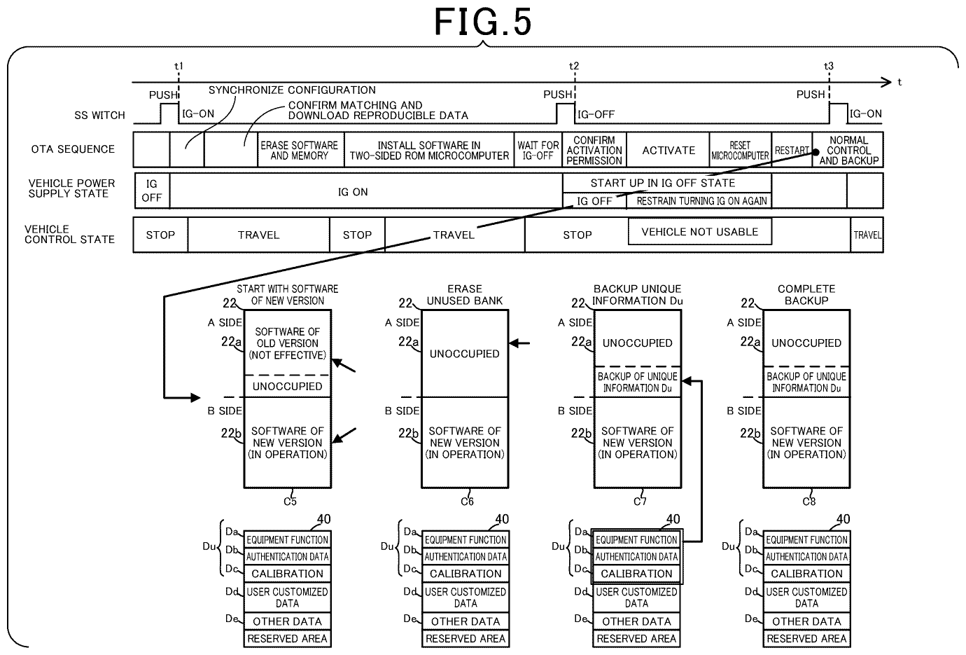

FIGS. 4 and 5 show a sequence of the software update process in time series along a time axis t. The update of the first software and the second software is performed at the same timing by the same process. The update of the first software is the same as the update of the second software, except that the backup process of the unique information Du is performed with the update.

In this description, the first software and the second software are stated as software unless they need to be distinguished from each other. The first microcomputer 10 and the second microcomputer 20 are stated as the microcomputer unless they need to be distinguished from each other, and the first memory 12 and the second memory 22 are stated as the memory unless they need to be distinguished from each other.

As shown in FIG. 4, upon recognition of IG on operation of the SS switch 7 at time t1, the mobile body control device 1 starts an OTA sequence to execute synchronizing configuration → downloading reproducible data (software data of a new version) from the mobile body management server 310 → erasing software → installing software (installing software into the double-sided ROM microcomputer).

FIG. 4 shows an example in which software update is performed through OTA when the mobile body control device 1 recognizes the IG on operation of the SS switch 7, though the software update may be performed at other times. For example, upon reception of a software update instruction signal transmitted from another ECU via the communication line 41, the mobile body control device 1 may perform the software update process by OTA, that is, synchronizing configuration → downloading reproducible data (software data of a new version) from the mobile body management server 310 → erasing software → installing software (installing software into the double-sided ROM microcomputer).

In FIGS. 4 and 5, reference signs C1 through C8 denote the situation of the second memory 22 at an appropriate time point in the OTA sequence, together with the non-volatile memory 40. The reference sign C1 denotes the situation where the A-side bank 22a is an area of the second memory 22 where the software of an old version before update is stored, and the unique information Du is backed up in the B-side bank 22b. In the case of updating the software, it is necessary to erase an unused bank, i.e. the bank 22b that is different from the bank 22a, in which the software of the old version that is currently effective and in operation is stored.

Just before the unused bank is erased, the second microcomputer 20 performs the process of confirming the matching between the unique information Du written in the bank 22b and the unique information Du written in the non-volatile memory 40.

In this case, the second microcomputer 20 determines that the unique information Du in the non-volatile memory 40 is highly reliable information when it is determined that the unique informations Du match each other. When it is determined that there is no match, the second microcomputer 20 checks the reliability of the respective unique information Du. When the unique information Du written in the non-volatile memory 40 is determined to be information of low reliability and the unique information Du written in the bank 22b is determined to be highly reliable information, the second microcomputer 20 rewrites the unique information Du written in the bank 22b over the unique information Du written in the non-volatile memory 40.

This makes it possible to avoid the situation where the low reliability unique information Du remains in the non-volatile memory 40. Note that publicly known processing such as CRC, check sub, parity, and MD can widely be applied to the process of checking the reliability.

Next, the microcomputer erases the unused bank, starts writing the software of a new version into the unused bank, and waits for an IG off operation after writing is completed. Reference sign C2 denotes the situation where the unused bank is erased, and reference sign C3 denotes the situation where the software of the new version is written.

At time t2, the microcomputer starts an activation process upon recognition of the IG off operation of the SS switch 7. The activation process includes confirming the permission of the user for activation, turning IG off, activating software, and resetting the microcomputer.

The microcomputer confirms the permission for activation (confirms update of software to a new version, etc.), and when the permission is confirmed, the microcomputer turns IG off (including setting to prohibit turning power on again), activates the software of the new version, and resets itself. Reference sign C4 denotes the situation where the software of the new version is written into the B side and the activation process is completed. When the microcomputer is restarted (equivalent to when the processor is restarted), the software of the new version becomes effective.

In FIG. 5, reference sign C5 denotes the situation where the software that is started by the microcomputer when IG is turned on is switched from the software of the old version stored on the A side to the new version stored on the B side.

Then, when the mobile body 100 is stopped or the mobile body 100 is in an IG off state (power off state), the second microcomputer 20 erases the software of the old version written in the unused bank (erasure of the unused bank) and starts the process of writing the unique information Du into the unused bank. Reference sign C6 denotes the situation where the A-side bank 22a storing the software of the old version is erased. Reference sign C7 denotes the situation where the unique information Du in the non-volatile memory 40 is written into the A-side bank 22a that is unoccupied.

When the mobile body 100 is neither stopped nor in the IG off state (power off state), the second microcomputer 20 postpones erasure of the unused bank and the backup process until the mobile body 100 is stopped or enters the IG off state (power off state).

Thus, the erasure of the unused bank and the backup process can be performed in scenes with a small processing volume such as where the mobile body 100 is stopped and the mobile body 100 is in the IG off state (power off state). This can prevent concentration of processing load when the mobile body 100 is traveling.

When the microcomputer recognizes the IG on operation of the SS switch 7 at time t3, the microcomputer confirms that the update of the software from the old version to the new version is completed and the backup of the unique information Du to the unused bank is completed. Reference sign C8 denotes the situation where the backup process of the unique information Du to the unused bank is completed.

As described in the foregoing, the mobile body control device 1 of the present embodiment includes the first memory 12 and the second memory 22, which are formed of a rewritable dual bank ROM, software is written in one of two banks of each of the memories 12 and 22, and the software of a new version is written in an unoccupied bank to execute the update process of the software. When the software is not written in the other bank of the second memory 22, the mobile body control device 1 performs the process of writing the unique information Du of the mobile body 100 written in the non-volatile memory 40 to the other bank of the second memory 22.

With the configuration, the unoccupied bank in the dual bank ROM is used as a backup area for the unique information Du, which can restrain the situation of the unique information Du being lost, resulting in improvement of the reliability of the unique information Du. Since the reliability of the unique information Du is improved, the normal operation can continue. This in turn contributes to the development of sustainable transportation systems by further enhancing the safety of the traffic. Note that the non-volatile memory 40 is an example of a further memory in the present disclosure.

The mobile body control device 1 writes the unique information Du into the other bank of the second memory 22 upon detecting that the software is not written in the other bank at the start-up of the mobile body 100. This allows the unoccupied bank of the dual bank ROM to be used as a backup area for the unique information Du when the mobile body 100 is started up. As a result, it is possible to suppress the loss of the unique information Du after the start-up, and the reliability of the unique information Du is improved.

The software update process includes a process of erasing the software of an old version, and after the software of the old version is erased, the mobile body control device 1 writes the unique information Du into the bank where the software of the old version has been erased. This allows the unique information Du to be backed up in the unoccupied bank that is switched by the software update.

The mobile body control device 1 also determines whether or not the unique information Du in the unoccupied bank matches the unique information Du in the non-volatile memory 40 at the start of the software update process, and when matched, the unique information in the unoccupied bank is erased. As a result, after confirming that the unique information Du in the non-volatile memory 40 is highly reliable information, an area for writing the software of the new version can be secured.

When there is no match, the mobile body control device 1 performs reliability determination to determine reliability of data regarding the unique information in the unoccupied bank and the unique information in the non-volatile memory 40, and when the unique information Du in the unoccupied bank is reliable data, the unique information Du in the non-volatile memory 40 is updated to the unique information Du in the unoccupied bank. This makes it possible to avoid the situation where the low reliability unique information Du remains in the non-volatile memory 40, resulting in improvement in reliability of the unique information Du.

The software update process includes an activation process of the software of the new version, and after the activation process is completed and the software of the old version is erased, the mobile body control device 1 writes the unique information Du written in the non-volatile memory 40 into the bank where the software of the old version has been erased. This makes it possible to back up the unique information Du in the unoccupied bank after the software is updated, and therefore the unique information Du can be backed up while the downtime of the mobile body 100 is minimized.

Since the erasure of the software of the old version is executed when the mobile body 100 is stopped or the mobile body 100 is in the power off state, the software is erased in scenes with a small processing volume, so that the processing load does not concentrate when the mobile body 100 is traveling.

### [4. Other Embodiments]

The embodiment described above is merely one embodiment of the present invention, and any deformations and applications are possible without departing from the concept of the present invention.

The configuration of the mobile body control device 1 shown in FIG. 1 is exemplary, and the configuration may be changed as appropriate. FIG. 1 is a configuration diagram in which the configuration of the mobile body control device 1 is categorized and shown according to main processing contents for easy understanding of the present invention, and therefore, the configuration of the mobile body control device 1 may be configured according to other categories. The processing of each component member may be executed by a single hardware unit or may be executed by a plurality of hardware units. The processing by each component member may be executed by a single program or may be executed by a plurality of programs.

### [5. Configurations Supported by Above Embodiment]

The embodiment disclosed is a specific example of the following configurations.

(Configuration 1) A mobile body control device, including: a processor; a memory that stores software used by the processor, the memory being a rewritable dual bank ROM with the software being written in one of two banks; a software update unit that writes the software of a new version into an unoccupied bank and executes a software update process; a further memory in which a unique information of the mobile body is written; and a backup control unit that writes the unique information into another bank of the memory when the software is not written in the other bank.

According to the mobile body control device of the configuration 1, the unoccupied bank in the dual bank ROM is used as a backup area for the unique information, which can restrain the situation where the unique information is lost, resulting in improvement in reliability of the unique information. Since the reliability of the unique information is improved, normal operation can continue.

(Configuration 2) The mobile body control device according to configuration 1, in which the backup control unit writes the unique information into the other bank upon detecting that the software is not written in the other bank at a start-up of the mobile body.

According to the mobile body control device of the configuration 2, the unoccupied bank in the dual bank ROM can be used as the backup area for the unique information at the start-up of the mobile body, which improves the reliability of the unique information.

(Configuration 3) The mobile body control device according to configuration 1 or 2, in which the software update process includes a process of erasing the software of an old version, and after the software of the old version is erased, the backup control unit writes the unique information into the bank where the software of the old version has been erased.

The mobile body control device of configuration 3 allows the unique information to be backed up in the unoccupied bank that is switched by the software update.

(Configuration 4) The mobile body control device according to any one of configurations 1 to 3, in which the backup control unit determines whether or not the unique information in the other bank matches the unique information in the further memory at a start of the software update process, and when matched, the unique information in the other bank is deleted.

According to the mobile body control device of configuration 4, after confirming that the unique information Du in the further memory is highly reliable information, an area for writing the software of the new version can be secured.

(Configuration 5) The mobile body control device according to configuration 4, in which when the unique informations do not match each other, the backup control unit performs reliability determination to determine reliability of data regarding the unique information in the other bank and the unique information in the further memory, and when the unique information in the other bank is reliable data, the backup control unit updates the unique information in the further memory to the unique information in the other bank.

The mobile body control device of configuration 5 makes it possible to avoid the situation where the low reliability unique information remains in the further memory, resulting in improvement in reliability of the unique information.

(Configuration 6) The mobile body control device according to configuration 3, in which the software update process includes an activation process of the software of the new version, and after the activation process is completed and the software of the old version is erased, the backup control unit writes the unique information written in the further memory into the bank where the software of the old version has been erased.

The mobile body control device of configuration 6 makes it possible to back up the unique information in the unoccupied bank after the software is updated, and therefore the unique information can be backed up while the downtime of the mobile body is minimized.

(Configuration 7) The mobile body control device according to configuration 3 or 6, in which erasure of the software of the old version is executed when the mobile body is stopped or the mobile body is in a power off state.

The mobile body control device of configuration 7 can prevent concentration of processing load when the mobile body is traveling.

(Configuration 8) A mobile body control method executed by a mobile body control device including a processor, a memory that stores software used by the processor, and a further memory in which a unique information of a mobile body is written, the memory being a rewritable dual bank ROM with the software being written in one of two banks, the method including: a software update step of writing the software of a new version in an unoccupied bank and executing a software update process; and a backup step of writing the unique information in another bank of the memory when the software is not written in the other bank.

When the mobile body control method of configuration 8 is executed by the mobile body control device, the operational effects similar to those of the mobile body control device of configuration 1 can be obtained.

(Configuration 9) A program for causing at least some part of the mobile body control device, including a processor, a memory that is a rewritable dual bank ROM that stores software used by the processor, the software being written in one of two banks, and a further memory in which a unique information of a mobile body is written, to function as: a software update unit that writes the software of a new version into an unoccupied bank and executes the software update process; and a backup control unit that writes the unique information into another bank of the memory when the software is not written in the other bank.

When the program of configuration 9 is executed by the mobile body control device, the operational effects similar to those of the mobile body control device of configuration 1 can be obtained.

### REFERENCE SIGNS LIST

1 Mobile body control device, 2 Central ECU, 5 Communication unit, 6 Display, 7 SS switch, 8 IG relay, 10 First microcomputer, 11 First processor, 12 First memory, 13 First communication circuit, 20 Second microcomputer, 21 Second processor, 22 Second memory, 23 Second communication circuit, 30, 32, 33 Input circuit, 35 Output circuit, 40 Non-volatile memory (a further memory), 100 Mobile body, 121 First software of old version, 122 First software of new version, 200 In-vehicle device, 221 Second software of old version, 222 Second software of new version, 300 Communication network, 310 Mobile body management server, Da Equipment function data, Db Authentication data, Dc Calibration data, Dd User customized data, De Other data, Du Unique information.

1. A mobile body control device, comprising:
a processor;
a memory that stores software used by the processor, the memory being a rewritable dual bank ROM with the software being written in one of two banks;
a software update unit that writes the software of a new version into an unoccupied bank and executes a software update process;
a further memory in which a unique information of the mobile body is written; and
a backup control unit that writes the unique information into another bank of the memory when the software is not written in the other bank.

2. The mobile body control device according to claim 1, wherein the backup control unit writes the unique information into the other bank upon detecting that the software is not written in the other bank at a start-up of the mobile body.

3. The mobile body control device according to claim 1, wherein
the software update process includes a process of erasing the software of an old version, and
after the software of the old version is erased, the backup control unit writes the unique information into the bank where the software of the old version has been erased.

4. The mobile body control device according to claim 3, wherein the backup control unit determines whether or not the unique information in the other bank matches the unique information in the further memory at a start of the software update process, and when matched, the unique information in the other bank is erased.

5. The mobile body control device according to claim 4, wherein when the unique informations do not match each other, the backup control unit performs reliability determination to determine reliability of data regarding the unique information in the other bank and the unique information in the further memory, and when the unique information in the other bank is reliable data, the backup control unit updates the unique information in the further memory to the unique information in the other bank.

6. The mobile body control device according to claim 3, wherein
the software update process includes an activation process of the software of the new version, and
after the activation process is completed and the software of the old version is erased, the backup control unit writes the unique information written in the further memory into the bank where the software of the old version has been erased.

7. The mobile body control device according to claim 6, wherein erasure of the software of the old version is executed when the mobile body is stopped or the mobile body is in a power off state.

8. A mobile body control method executed by a mobile body control device including a processor, a memory that stores software used by the processor, and a further memory in which a unique information of a mobile body is written, the memory being a rewritable dual bank ROM with the software being written in one of two banks, the method comprising:
a software update step of writing the software of a new version in an unoccupied bank and executing a software update process; and
a backup step of writing the unique information in another bank of the memory when the software is not written in the other bank.

9. A non-transitory computer-readable storage medium storing a program for causing at least some part of a mobile body control device, including a processor, a memory that is a rewritable dual bank ROM that stores software used by the processor, the software being written in one of two banks, and a further memory in which a unique information of a mobile body is written, to function as:
a software update unit that writes the software of a new version into an unoccupied bank and executes a software update process; and
a backup control unit that writes the unique information into another bank of the memory when the software is not written in the other bank.
